(19) United States
(12) Patent Application Publication
(10) Pub. No.: US 2004/0206403 A1
(43) Pub. Date: Oct. 21, 2004

(54) Check valve and a hydraulic continuously variable transmision incorporating same

(75) Inventors: Mitsuru Saitou, Saitama (JP); Yasushi Fujimoto, Saitama (JP); Kazuhiro Takeuchi, Saitama (JP)

Correspondence Address: CARRIER BLACKMAN AND ASSOCIATES, 24101 NOVI ROAD, SUITE 100, NOVI, MI, 48375

(73) Assignee: Honda Motor Co., Ltd., Tokyo (JP)

(21) Appl. No.: 10/802,261

(22) Filed: Mar. 17, 2004

(30) Foreign Application Priority Data
Mar. 25, 2003 (JP) 2003-081968

(51) Int. Cl. F16K 15/04

(52) U.S. Cl. 137/539

(57) ABSTRACT

A check valve for use in a continuously variable transmission includes a valve body having an axial through-communicating oil path and a cylindrical fitting recess part opened at an axial end thereof, an insert member having a cylindrical fitting projection part fitted in the fitting recess part to attach the insert member to the valve body, and also having an accommodating space therein opened at one side of the insert member near the fitting projection part, and a valve element and a spring disposed in the accommodating space such that the valve element is normally urged by the spring to close an opening of the communicating oil path. The cylindrical fitting recess part has one of an annular reduced diameter portion and an annular expanded diameter portion at an inner periphery thereof,

the cylindrical fitting projection part has a corresponding one of an annular reduced diameter portion and an annular expanded diameter portion at an outer periphery thereof, and diameters of the fitting recess part and the fitting projection part, including the annular reduced diameter portions or the annular expanded diameter portions, are such that the insert member is press-fit to the fitting recess part when attaching the insert member to the valve body.

### CROSS-REFERENCE TO RELATED APPLICATIONS

The present invention claims priority under 35 USC 119 based on Japanese patent application No. 2003-081968, filed Mar. 25, 2003.

### BACKGROUND OF THE INVENTION

1. Field of the Invention

The present invention relates to a structure of a check valve (ex., a ball type check valve), more particularly to a structure of a check valve to control supply of a charge oil in a hydraulic continuously variable transmission configured by a hydraulic pump and a hydraulic motor that are connected to each other through a closed hydraulic circuit.

2. Description of the Background Art

Conventionally, there have been many types of hydraulic continuously variable transmissions put for practical use. In each of those transmissions, a hydraulic pump and a hydraulic motor are combined. Such a hydraulic continuously variable transmission is disclosed, for example, in Official gazette of JP-A No. 42446/6 and Official gazette of JP No. 2920772 respectively. Both Official gazette of JP-A No. 42446/6 and Official gazette of JP No. 2920772 are disclosures of the inventor of the present invention. The hydraulic continuously variable transmission disclosed in each of the discussed patent documents comprises a swash plate plunger pump, a swash plate plunger motor, and a closed hydraulic circuit connecting the discharge port and the intake port of the swash plate plunger pump to the intake port and the discharge port of the swash plate plunger motor. A swash plate member of the pump is driven by an engine. A pump cylinder and a motor cylinder are connected as a set and the set is disposed on an output shaft. A swash plate member of the motor rocks around a shaft at a right angle to the center of rotation of the output shaft, so that the motor's swash plate angle is adjusted variably.

In such a hydraulic continuously variable transmission, the driving force of the hydraulic pump is transmitted to the hydraulic motor through an operation oil circulating in the closed hydraulic circuit to change the rotational driving force continuously and variably. The operating oil circulating in the closed hydraulic circuit often leaks from a sliding part between the motor plunger and the plunger hole, as well as from a distribution valve disposed between the pump and the motor. Consequently, the operating oil must be kept supplied to make up those leaks. This is why the transmission is provided with a charge pump used to supply the additional oil to a low pressure side oil path in the closed hydraulic circuit. A check valve is used to control the supply of the charge oil to the low pressure side oil path as needed.

One of such well-known check valves is configured by a valve body in which an axial through communicating oil path is formed, a insert member to be fit and fixed in a fitting recess part formed in the valve body, and a set of a valve element (ex., a ball valve) and a spring disposed in an internal space while the insert member is fit in the fitting recess part to be fixed to the valve body. The valve element is pushed by the spring to close the opening of the communicating oil path. In Official gazette of JP-A No. 42446/6 and Official gazette of JP No. 2920772 described above, a ball valve is used as the valve element. However, as disclosed in Official gazette of JP-A No. 6166/5, there is also another well-known check valve that uses a poppet type valve element.

However, the check valve configured as described above requires a means for preventing the insert member from falling off the valve body while the insert member is fit in the fitting recess part to be fastened to the valve body. Conventionally, a pin hole orthogonal to the center axis is formed in each of the valve body and the insert member and the pin inserted in the hole prevents the insert member from falling off the valve body while the insert member is fit in and fastened to the valve body as described above. In this structure, however, the pin itself is needed and processes for forming the pinhole and inserting the pin in the hole are required. Consequently, the manufacturing cost of the check valve, as well as the number of steps/assembly processes increase. This has been a conventional problem.

### SUMMARY OF THE INVENTION

Under such circumstances, it is an object of the present invention to provide a check valve that is simple in structure, capable of preventing the insert member from falling off and easy to be processed and assembled.

In order to solve the above conventional problems and achieve the above object, according to one aspect of the present invention there is provided a check valve which comprises a valve body having an axial through-communicating oil path and a cylindrical fitting recess part opened at an axial end thereof, an insert member having a cylindrical fitting projection part fitted in the fitting recess part to attach the insert member to the valve body, and also having an accommodating space therein opened at one side of the insert member near the fitting projection part, and a valve element and a spring disposed in the accommodating space such that the valve element is normally urged by the spring to close an opening of the communicating oil path. The cylindrical fitting recess part has one of an annular reduced diameter portion and an annular expanded diameter portion at an inner periphery thereof, the cylindrical fitting projection part has a corresponding one of an annular reduced diameter portion and an annular expanded diameter portion at an outer periphery thereof, and diameters of the fitting recess part and the fitting projection part, including the annular reduced diameter portions or the annular expanded diameter portions, are such that the insert member is press-fit to the fitting recess part when attaching the insert member to the valve body.

In the case of a check valve configured as described above, when the fitting projection part is fit in the fitting recess part to fasten the insert member to the valve body, the presence of the reduced diameter portions or the expanded diameter portions makes it necessary for the fitting projection part to be press-fit in the fitting recess part. This fitting makes it possible to keep the insert member fastened to the valve body. Both of the insert member and the valve body can thus be kept engaged easily only by fitting the insert member in the valve body in the simply structured check valve.

Similarly to solve the above conventional problems and achieve the above object, according to another aspect of the present invention there is provided a check valve for use in a hydraulic flow passage which comprises: a valve body having an axial oil path formed therein, and having a cylindrical fitting recess formed in one end thereof in communication with the oil path, wherein a valve seat is defined where the fitting recess joins the axial oil path; an insert member adapted to fit in the fitting recess of the valve body, the insert member including a cylindrical fitting projection and having an accommodating space defined therein; and a valve element and a spring disposed in the accommodating space when the fitting projection is installed in said fitting recess to attach the insert member to the valve body. The valve element is normally biased against the valve seat by the spring to block fluid flow through the axial oil path; and the cylindrical fitting projection of the insert member is press-fit into the fitting recess of the valve body to form an interference fit therebetween effective to retain the insert member in engagement with the valve body.

Again, in the case of a check valve configured as according to this aspect of the invention, the same advantages are achieved as with the check valve according to the first aspect.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a cross sectional view of a hydraulic continuously variable transmission that includes a check valve according to an illustrative embodiment of the present invention.

FIG. 2 is a side view of an off-road vehicle that uses the hydraulic continuously variable transmission according to an embodiment of the present invention.

FIG. 3 is a top plan view of the off-road vehicle that uses the hydraulic continuously variable transmission according to an embodiment of the present invention.

FIG. 4 is a rear view of the off-road vehicle that uses the hydraulic continuously variable transmission according to an embodiment of the present invention.

FIG. 5 is a schematic chart of a power transmission route of a power unit that includes the hydraulic continuously variable transmission according to an embodiment of the present invention.

FIG. 6 is a cross sectional view of part of the hydraulic continuously variable transmission according to an embodiment of the present invention.

FIG. 7 is a cross sectional view of the hydraulic continuously variable transmission according to an embodiment of the present invention.

FIG. 8 is an enlarged cross sectional view of part of the hydraulic continuously variable transmission according to an embodiment of the present invention.

FIGS. 9(A)-9(C) are sectional views showing a structure of a check valve used in the hydraulic continuously variable transmission, including the structure of a valve body and an insert member according to an embodiment of the present invention.

FIG. 110(A) is an expanded cross sectional view of a part in which the check valve of FIGS. 9(A)-9(C) is fit according to an embodiment of the present invention.

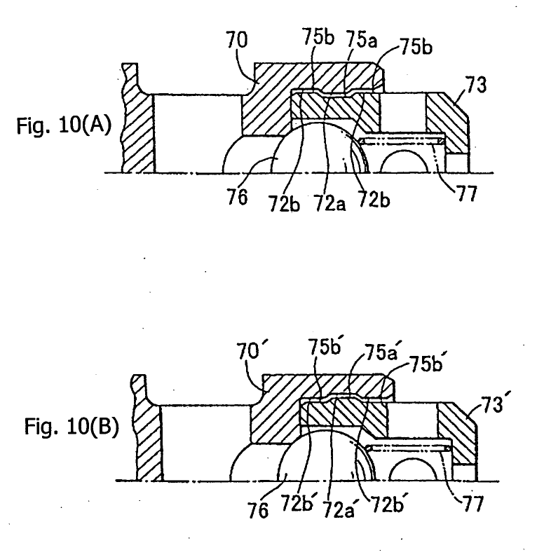

FIG. 10(B) is similar to FIG. 10(A), but shows a second embodiment of the invention

### DETAILED DESCRIPTION

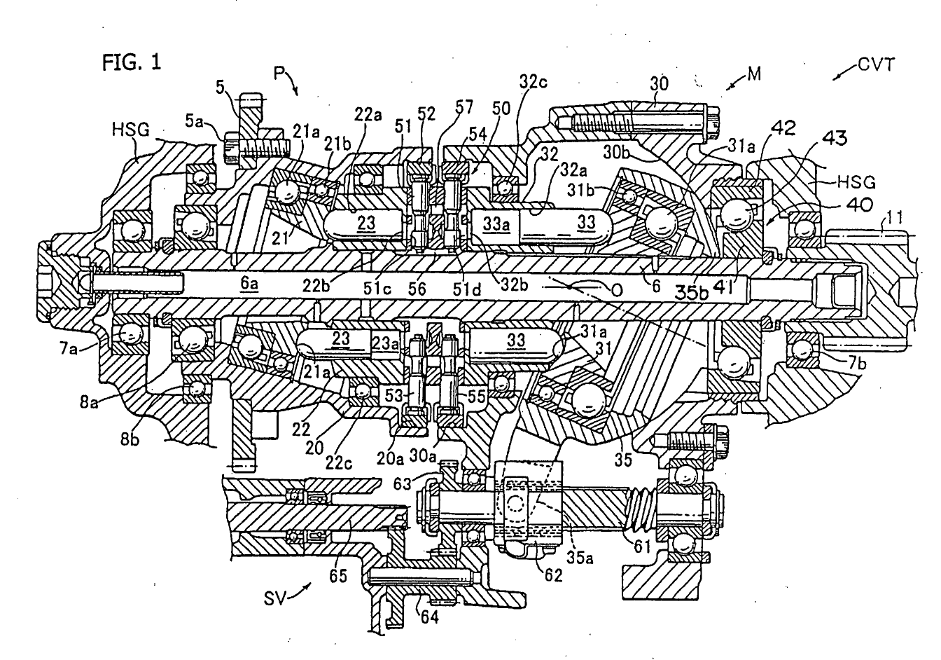

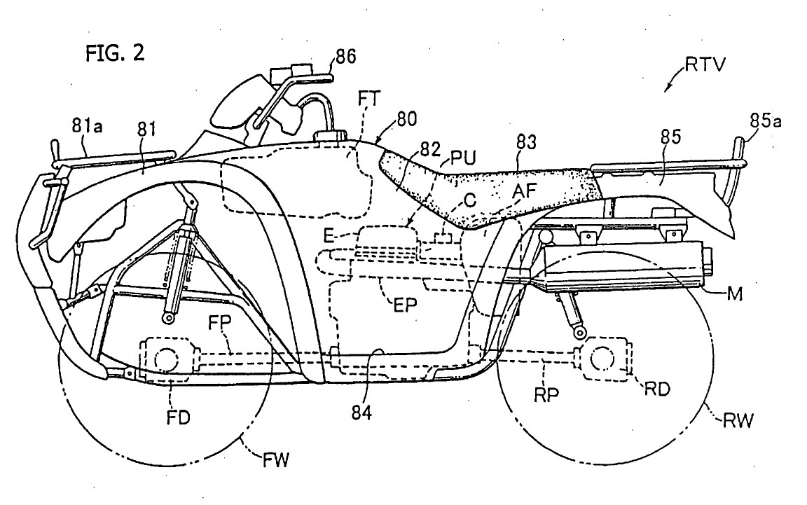

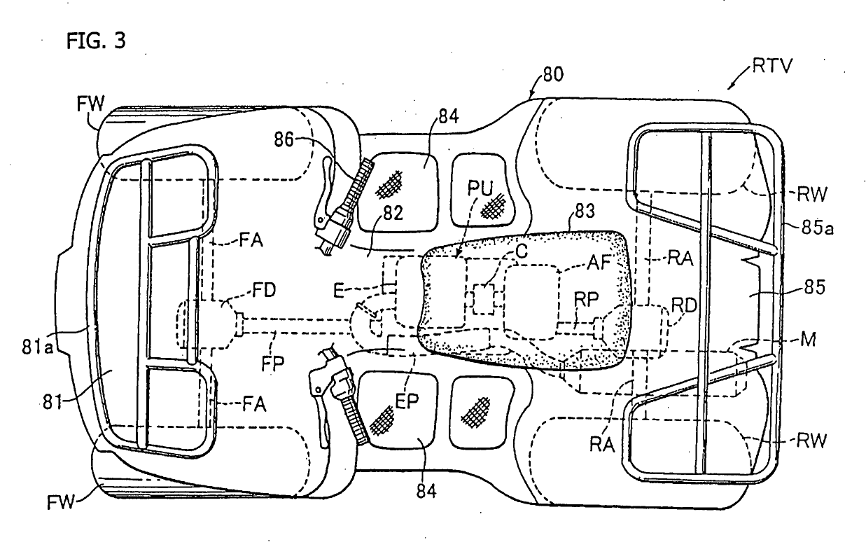

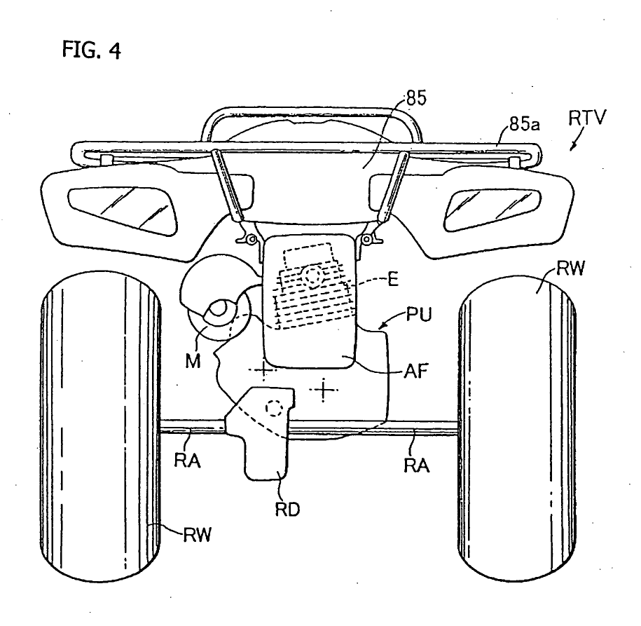

Hereunder, embodiments of the present invention will be described with reference to the accompanying drawings. FIGS. 2 through 4 show an off-road vehicle RTV that uses a hydraulic continuously variable transmission provided with the check valve of the present invention. This vehicle RTV includes a power unit PU built in the vehicle body 80 having an internal frame structure, as well as front and rear wheels FW and RW driven by an output of the power unit PU. The vehicle body 80 is configured by a front fender part 81 provided with a front guard 81a and located at the front portion of the vehicle body, a saddle part 82 swollen in the center of the vehicle body and extended in the front-rear direction, right and left step parts 84 formed in the lower right and left portions of the saddle part 82 so as to be extended to both right and left, and a rear fender 85 provided with a rear guard 85a and located at the rear portion of the vehicle body. The saddle part 82 is provided with a driver's seat 83 on which the driver sits astride. The driver who sits astride on the seat 83 puts his/her feet on the right and left step parts 84 and takes the steering wheel 86 provided rockably in front of him/her for steering the vehicle. A fuel tank FT is disposed in front of the saddle part 82 as shown in FIG. 1.

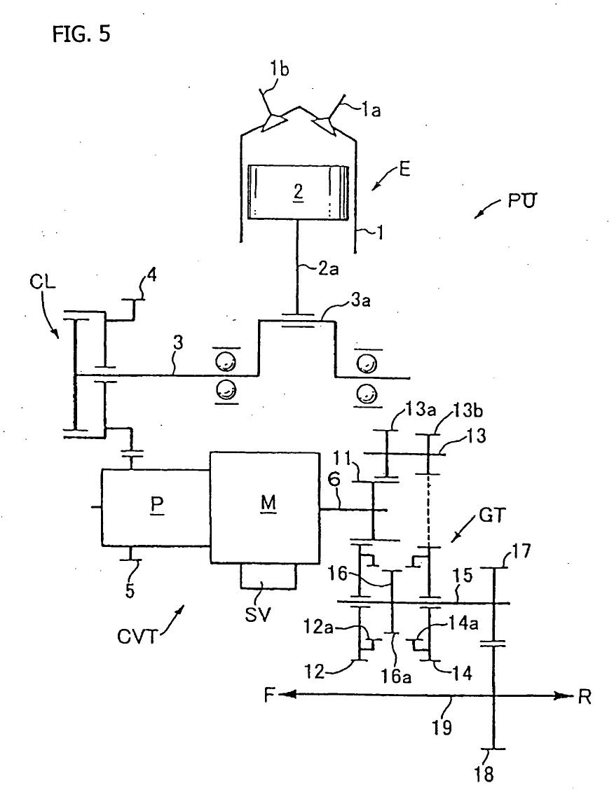

The power unit PU is disposed in the saddle part 82. This power unit PU, to be described later in detail, is configured by an engine E, a main clutch CL, a hydraulic continuously variable transmission CVT, and a transmission gear array GT (see FIG. 5). The engine E sucks a mixed gas generated in a carburetor C. The mixed gas is generated from the air sucked through an air filter AF and a fuel in the fuel tank FT. The mixed gas is burned in a cylinder to generate a rotational driving force. The exhaust air exhausted from the engine E is discharged from an exhaust pipe EP through a muffler M.

The rotational driving force of the engine E is varied in speed by the crank shaft, then through the main clutch CL, the hydraulic continuously variable transmission CVT, and the transmission gear array GT and transmitted to the front and rear propeller shafts FP and RP. The front propeller shaft FP is connected to a front differential mechanism FD and the rotational driving force transmitted to the front propeller shaft FP is then transmitted from the front differential mechanism FD to the right and left front wheels FW through right and left front axle shafts FA, thereby the front wheels FW are driven. The rear propeller shaft RP is connected to a rear differential mechanism RD and the rotating driving force transmitted to the rear propeller shaft RP is transmitted from the rear differential mechanism RD to the right and left rear wheels RW through right and left rear axle shafts RA, thereby the rear wheels RW are driven.

Next, the power unit PU will be described with reference to FIG. 5. The power unit PU is configured by an engine E for generating a rotational driving force, a main clutch CL for controlling transmission of the rotational driving power, a hydraulic continuously variable transmission CVT for shifting gears continuously and variably with respect to the rotational driving force transmitted through the main clutch CL, and a transmission gear array GT for switching the direction of and transmitting the rotational output from the hydraulic continuously variable transmission CVT. This power unit PU is disposed in the saddle part 82 so that the engine crankshaft is extended in the front-rear direction of the vehicle body.

The engine E includes a piston 2 disposed in a cylinder 1 provided with an intake valve 1a and an exhaust valve 1b at its head part. In the engine E, a mixed gas is generated from the air sucked through the air filter AF and the fuel in the fuel tank FT in the carburetor C as described above. This mixed gas is sucked into the cylinder through the intake valve 1a opened at a predetermined timing, then burned in the cylinder to reciprocate the piston 2. The reciprocation of the piston 2 is transmitted to the crank part 3a through a link rod 2a, thereby the crank shaft 3 is rotated. The main clutch CL is provided at an end portion of the crank shaft 3 and used to control engagement/disengagement of an input drive gear 4 disposed rotationally on the crank shaft 3 with the crank shaft 3. Consequently, according to the engagement/disengagement controlled by the main clutch CL, the rotation of the crankshaft 3 is transmitted to the input drive gear 4. The main clutch CL is, for example, a centrifugal clutch.

The hydraulic continuously variable transmission CVT includes a swash plate plunger type hydraulic pump P and a swash plunger type hydraulic motor M. An input follower gear 5 connected to a pump casing of the swash plunger type hydraulic pump P is engaged with the input drive gear 4 and the rotation of the engine E is transmitted to the input follower gear 5, thereby the pump casing rotates. The details of the hydraulic continuously variable transmission CVT will be described later. An output rotation that is varied in speed continuously and variably by the hydraulic continuously variable transmission CVT is transmitted to a transmission output shaft 6.

A transmission output gear 11 included in the transmission gear array GT is connected to the transmission output shaft 6. The rotation of the transmission output shaft 6 is transmitted from the transmission output gear 11 to the object through the transmission gear array GT. The transmission gear array GT includes a counter shaft 15 and an idler shaft 13 disposed in parallel to the transmission output shaft 6 respectively. A forward gear 12 and a backward gear 14 are disposed rotationally at the counter shaft 15. And, an output drive gear 17 is connected to the counter shaft 15. On the other hand, a first idler gear 13a and a second idler gear 13b are connected to the idler shaft 13. The forward gear 12 and the first idler gear 13a are engaged with the transmission output gear 11 respectively. The second idler gear 13b engages with the backward gear 14.

The forward gear 12 is provided with an inner gear clutch gear 12a and the backward gear 14 is provided with an inner gear clutch gear 14a. A clutch sleeve 16 is provided between the forward gear 12 and the backward gear 14 so as to rotate together with the counter shaft 15 and move axially. An outer gear clutch gear 16a is formed at the outer periphery of the clutch sleeve 16 and moves the clutch sleeve 16 axially to be engaged selectively with either the inner gear clutch gear 12a or 14a, thereby a dog-teeth clutch is formed. This clutch sleeve 16 is movable axially according to the driver's shift lever operation forward/backward.

If the driver operates the shift lever forward, the clutch sleeve 16 moves to the left in FIG. 5 and the outer gear clutch gear 16a engages with the inner gear clutch gear 12a, thereby the forward gear 12 is connected to the counter shaft 15. In this state, therefore, the rotation of the transmission output gear 11 is transmitted to the counter shaft 15 from the forward gear 12, thereby the output drive gear 17 is driven rotationally.

On the other hand, if the driver operates the shift lever backward, the clutch sleeve 16 moves to the right in FIG. 5, then the outer gear clutch gear 16a engages with the inner gear clutch gear 14a, thereby the backward gear 14 is connected to the counter shaft 15. In this state, the rotation of the transmission output gear 11 is transmitted from the first idler gear 13a to the second idler gear 13b through the idler shaft 13, then from the second idler gear 13b to the counter shaft 15 through the backward gear 14 engaged with the second idler gear 13b. The output drive gear 17 is thus driven rotationally. At that time, the rotational direction of the output drive gear 17 is inverted (backward) from that of the forward shift lever operation described above.

The output drive gear 17 is engaged with the output follower gear 18 connected to the drive shaft 19, so that the rotation of the output drive gear 17 is transmitted to the drive shaft 19 through the output follower gear 18. The front end of the drive shaft 19 is connected to the propeller shaft FP and the rear end of the drive shaft 19 is connected to the rear propeller shaft RP. The rotational driving force transmitted to the drive shaft 19 is thus transmitted to the front and rear propeller shafts FP and RP, thereby the front and rear wheels FW and RW are driven as described above.

Next, the hydraulic continuously variable transmission CVT will be described with reference to FIG. 1 and FIG. 6 through FIG. 8. The hydraulic continuously variable transmission CVT includes a swash plunger type hydraulic pump P and a swash plunger type hydraulic motor M. A transmission output shaft 6 is extended through the center of the hydraulic continuously variable transmission CVT. The transmission output shaft 6 is supported rotationally by ball bearings 7a and 7b with respect to a transmission housing HSG.

The hydraulic pump P is configured by a pump casing 20 disposed on the transmission output shaft 6 co-axially, as well as rotationally and relatively to the shaft 6, a pump swash plate member 21 disposed at a predetermined angle to the rotational center axis of the pump casing 20 in the pump casing 20, a pump cylinder 22 disposed so as to face the pump swash plate member 21, and a plurality of pump plungers 23 disposed slidably in a plurality of pump plunger holes 22a formed in a annular disposition pattern around the center axis of the pump cylinder 22 and extended axially in the pump cylinder 22. The pump casing 20 is supported rotationally by a bearing 8a on the transmission output shaft 6 and by another bearing 8b rotationally with respect to the transmission housing HSG. The swash plate member 21 of the pump is disposed rotationally around a shaft inclined by a predetermined angle from the bearings 21a and 21b with respect to the pump casing 20. The pump cylinder 22 is supported rotationally by a bearing 22c co-axially and relatively to the pump casing 20.

An input follower gear 5 is fastened by a bolt 5a and attached to the outer periphery of the pump casing 20. The outside end portion of the pump plunger 23 is protruded outward to contact-engage with the swash plate plane 21a of the pump swash plate member 21 and the inside end portion thereof located in the pump plunger hole 22a forms a pump oil tank 23a in the pump plunger hole 22a so as to face the valve body 51 of the distribution valve 50 (to be described later). Pump openings 22b that function as a discharge port and an intake port of the pump are formed at the end portion of the pump plunger hole 22. As described above, if the input follower gear 5 is driven rotationally, the pump casing 20 is also driven rotationally and the pump swash plate member 21 disposed therein rocks according to the rotation of the pump casing 20. The pump plunger 23 then reciprocates in the pump plunger hole 22a according to the rocking of the swash plate plane 21a. The operating oil in the pump oil tank 23a is thus compressed/expanded according to the reciprocation.

The hydraulic motor M is configured by a motor casing 30 connected fixedly to the transmission housing HSG, a motor rocking member 35 supported in slide-contact by a supporting spherical surface 30b formed on the inner surface of the motor casing 30 and rockably around the rocking center O extended at a right angle (vertically on the paper) to the center axis of the transmission output shaft 6, a motor swash plate member 31 supported rotationally by bearings 31a and 31b in the motor rocking member 35, a motor cylinder 32 facing the motor swash plate member 31, a plurality of motor plungers 33 disposed slidably in a plurality of motor plunger holes 32a formed in a annular disposition pattern axially around the center axis of the motor cylinder 32 in the motor cylinder 32. The motor cylinder 32 is supported rotationally by the motor casing 30 through a bearing 32c at its outer periphery.

The outside end portion of the motor plunger 33 is protruded outward and contact-engaged with a swash plate surface 31a of the motor swash plate member 31 and the inside end portion thereof located in the plunger hole 32a faces the valve body 51 and forms a motor oil tank 33a in the motor plunger hole 32a. Motor openings 32b that function as a discharge port and an intake port of the motor are formed at the end portions of the motor plunger holes 32a. An arm part 35a formed by an end portion of the motor rocking member 35, which is protruded in the outer radial direction, is protruded outward in the diameter direction to be connected to a motor servo mechanism SV. The motor servo mechanism SV controls the movement of the arm part 35a to the right/left in FIG. 5, thereby controlling rocking of the motor rocking part 35 around the rocking center O. If the motor rocking member 35 rocks in such manner, the motor swash plate member 31 supported rotationally therein also rocks together with the member 35, thereby the swash plate angle changes.

A distribution valve 50 is disposed between the pump cylinder 22 and the motor cylinder 32. The valve body 51 of this distribution valve 50 is sandwiched between the pump cylinder 22 and the motor cylinder 32 and connected to them unitarily. The valve body 51 is also connected to the transmission output shaft 6. Consequently, the pump cylinder 22, the distribution valve 50, the motor cylinder 32, and the transmission output shaft 6 rotate all together.

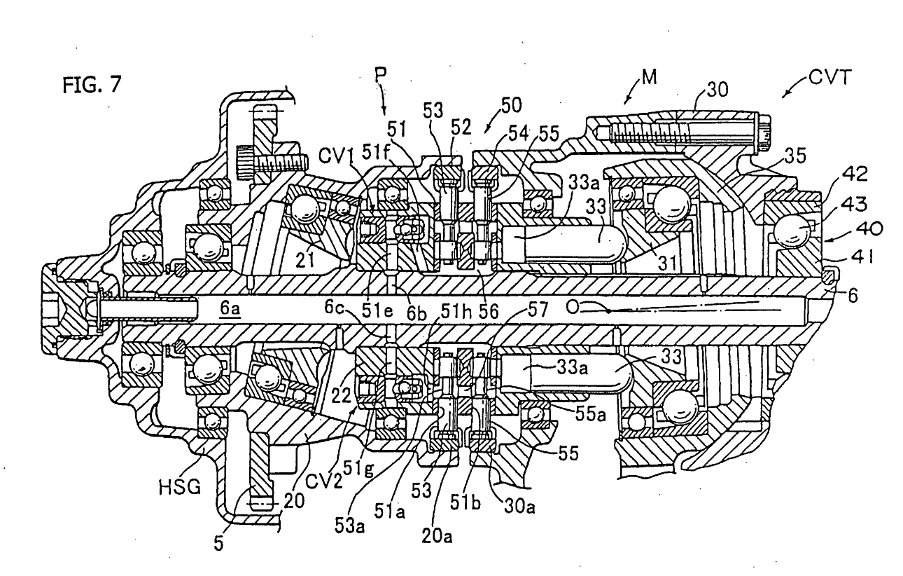

In order to make it easier to understand the reference numerals and symbols shown in FIG. 7, a plurality of pump side spool holes 51a and a plurality of motor side spool holes 51b are extended in both diameter and circumferential directions and disposed in two lines at equal pitches in the valve body 51 of the distribution valve 50. Pump side spools 53 are disposed slidably in the pump side spool holes 51a and motor side spools 55 are disposed slidably in the motor side spool holes 51b respectively.

The pump side spool holes 51a are formed so as to correspond to the pump plunger holes 22a. And, a plurality of pump side communicating paths 51c are formed in the valve body 51, so that pump openings 22b (pump oil tanks 23a) and pump side spool holes 51a communicate with each other therein. The motor side spool holes 51b are formed so as to correspond to the motor plunger holes 32a. A plurality of motor side communicating paths 51d are formed in the valve body 51, so that motor openings 32b (motor oil tanks 33a) and motor side spool holes 51b communicate with each other therein (FIG. 1).

In the distribution valve 50 is also disposed a pump side cam ring 52 so as to enclose the outer peripheral end portion of the pump side spool 53 and a motor side cam ring 54 so as to enclose the outer peripheral end portion of the motor side spool 55. The pump side cam ring 52 is attached within the range of the eccentric inner peripheral surface 20a formed on the inner surface of the tip of the pump casing 20 so as to be deviated from the rotational center axis of the pump casing 20. The pump side cam ring 52 rotates unitarily with the pump casing 20. The motor side cam ring 54 is attached to the eccentric inner peripheral surface 30a formed on the inner surface of the tip of the motor casing 30 so as to be deviated from the rotational center axis of the motor cylinder 32. The outer peripheral end of the pump side spool 53 is locked rotationally and relatively to the inner peripheral surface of the pump side cam ring 52 and the outer peripheral end of the motor side spool 55 is locked rotationally and relatively to the inner peripheral surface of the motor side cam ring 54.

An inside path 56 is formed between the inner peripheral surface of the valve body 51 and the outer periphery surface of the transmission output shaft 6. The inner periphery end portions of each pump side spool hole 51a and each motor side spool hole 51b communicate with this inside path 56. In addition, in the valve body 51 is also formed an outside path 57 for communicating each pump side spool hole 51a and each motor side spool hole 51b with each other.

Next, the operation of the distribution valve 50 configured as described above will be described. At first, the driving force of the engine E is transmitted to the input follower gear 5, thereby the pump casing 20 is driven rotationally. Then, the pump swash plate member 21 rocks according to the rotation of the pump casing 20. Consequently, the pump plunger 23 contact-engaged with the swash plate surface 21a of the pump swash plate member 21 reciprocates axially in the pump plunger hole 22a according to the rocking of the pump swash plate member 21. And, according to the movement of the pump plunger 23 inward, the operating oil is discharged from the pump oil tank 23a through the pump opening 22b. According to the movement of the pump plunger 23 outward, the operating oil is sucked into the pump oil tank 23a through the pump opening 22b.

At that time, the pump side cam ring 52 attached to the end portion of the pump casing 20 rotates together with the pump casing 20. However, because the pump side cam ring 52 is deviated from the center of the rotation of the pump casing 20, the pump side spool 53 reciprocates radially in the pump side spool hole 51a according to the rotation of the pump side cam ring 52. Because the pump side spool 53 reciprocates such way and the pump side spool 53 moves in the inner diameter direction as shown in the upper half in FIG. 1, the pump side communicating path 51c and the outside path 57 communicate with each other through the spool groove 53a and the pump side spool 53 moves in the outer diameter direction as shown in the upper half in FIG. 1, the pump side communicating path 51c and the inside path 56 communicate with each other through the spool groove 53a.

In that connection, the eccentric attaching position of the pump side cam ring 52 is set as follows when the swash plate member 21 rocks according to the rotation of the pump casing 20, whereby the pump plunger 23 reciprocates. The pump side cam ring 52 moves the pump side spool 53 in the inner diameter direction during a half rotation of the pump casing 20 in which the pump plunger 23 is pushed to the innermost point (referred to as the upper dead center) from the outermost point (referred to as the lower dead center) while the pump side cam ring 52 moves the pump side spool 53 in the outer diameter direction during a half rotation of the pump casing 20 in which the pump plunger 23 is pushed to the lower dead center from the upper dead center.

As a result, when the pump plunger 23 moves from the lower dead center to the upper dead center according to the rotation of the pump casing 20, thereby the operating oil is discharged from the pump oil tank 23a through the pump opening 22b, the operating oil is fed into the outside path 57 through the pump side communicating path 51c. On the other hand, when the pump plunger 23 moves from the upper dead center to the lower dead center according to the rotation of the pump casing 20, the operating oil in the inside path 56 is sucked into the pump oil tank 23a through the pump side communicating path 51c and the pump opening 22b. Consequently, when the pump casing 20 is driven rotationally, the operating oil discharged from the hydraulic pump P is supplied into the outside path 57 from where it is supplied to the hydraulic motor (M), and the operating oil is sucked into the hydraulic pump P from the inside path 56.

On the other hand, because the motor side cam ring 54 attached to the end portion of the motor casing 30 is also eccentric from the center of the rotation of the motor casing 30, the motor side spool 55 reciprocates in the radial direction in the motor side spool hole 51b according to the rotation of the motor cylinder 32. If the motor side spool 55 reciprocates such way and the motor side spool 55 moves in the inner radial direction as shown in the upper half in FIG. 1, the motor side communicating path 51d and the outside path 57 communicate with each other through a spool groove 55a. And, if the motor side spool 55 moves in the outer radial direction as shown in the lower half in FIG. 1, the motor side path 51d and the inside path 56 come to communicate with each other through the spool groove 55a.

In that connection, as described above, the operating oil discharged from the hydraulic pump P is fed into the outside path 57 and this operating oil is supplied from the motor side communicating path 51d to the motor oil tank 33a through the motor opening 32b, thereby the motor plunger 33 is pushed outward axially. Such way, the outside end portion of the motor plunger 33, which receives a pressure outward axially, is formed so as to be in sliding contact with a portion of the motor swash plate member 31 between the upper and lower dead centers as shown in FIG. 1 while the motor rocking member 35 rocks. Thus, the motor cylinder 32 is driven rotationally so that the motor plunger 33 moves from the upper dead center to the lower dead center along the motor swash plate member 31 due to the outward axial pressure force.

In order to drive the motor cylinder 32 rotationally in such manner, the eccentric attaching position of the motor side cam ring 54 is set as follows when the motor plunger 33 reciprocates on the inclined plane of the motor swash plate member 31 according to the rotation of the motor cylinder 32. The motor side cam ring 54 moves the motor side spool 55 in the outer radial direction during a half rotation of the motor cylinder 32 in which the motor plunger 33 is pushed to the innermost point (upper dead center) from the outermost point (lower dead center) while the motor side cam ring 54 moves the motor side spool 55 in the outer radial direction during a half rotation of the motor cylinder 32 in which the motor plunger 33 is pushed to the lower dead center from the upper dead center.

When the motor cylinder 32 is driven rotationally such way, the motor plunger 33 is pushed inward when it moves from the lower dead center to the upper dead center on the motor swash plate member 31 according to the rotation of the motor cylinder 32, thereby the operating oil in the motor oil tank 33a is fed into the inside path 56 from the motor opening 32b through the motor side communicating path 51d. The operating oil fed into the inside path 56 in such manner is sucked into the pump oil tank 23a through the pump side communicating path 51c and the pump opening 22b as described above.

As described above, when the pump casing 20 is driven rotationally by the rotating driving force received from the engine E, the operating oil is discharged into the outside path 57 from the hydraulic pump P, then fed into the hydraulic motor M so as to drive the motor cylinder 32 rotationally. The operating oil used to drive the motor cylinder 32 rotationally in such manner is then fed into the inside path 56 and sucked into the hydraulic pump P from the inside path 56. Thus, the closed hydraulic circuit for connecting the hydraulic pump P and the hydraulic motor M to each other is formed by the distribution valve 50. Specifically, the operating oil discharged from the hydraulic pump P according to the rotation of the hydraulic pump P is fed into the hydraulic motor M through the closed hydraulic circuit, thereby the hydraulic motor M is driven rotationally and furthermore the operating oil discharged after driving the hydraulic motor M rotationally is returned into the hydraulic pump P through the closed hydraulic circuit.

At that time, both of the pump cylinder 22 and the motor cylinder 32 that are connected to the transmission output shaft 6 come to rotate together. Therefore, when the motor cylinder 32 is driven rotationally as described above, the pump cylinder 22 also rotates together, thereby the relative rotational speed between the pump casing 20 and the pump cylinder 22 is reduced. As a result, the relationship between the rotation speed Ni of the pump casing 20 and the rotation speed No of the transmission output shaft 6 (that is, the rotational speed of each of the pump cylinder 22 and the motor cylinder 32) becomes as shown in the following expression (1) when the pump capacity is represented as Vp and the motor capacity is represented as Vm.

Vp(Ni−No)=VmNo Equation 1

The motor capacity Vm can be varied continuously according to the rocking of the motor rocking member 35 controlled by the motor servo mechanism SV. Consequently, if the motor capacity Vm is controlled so as to be varied continuously while the rotation speed Ni of the pump swash plate member 21 is fixed in the above equation (1), the rotation of the transmission output shaft 6 can be controlled so as to be varied continuously.

If the motor rocking member 35 is controlled so as to reduce the rocking angle, the motor capacity Vm is also reduced. If the pump capacity Vp and the rotation speed Ni of the pump swash plate member 21 are fixed in the above equation (1), the rotation of the transmission output shaft 6 is controlled to become closer to the rotational speed Ni of the pump swash plate member 21, that is, controlled to be varied continuously to the top gear shifting step. And, when the motor swash plate angle is 0, that is, when the plate stands erect, the Ni=No change gear ratio is obtained theoretically. Thus, the hydraulic circuit is locked, thereby the pump casing 20 rotates together with the pump cylinder 22, the motor cylinder 32, and the transmission output shaft 6 to transmit a mechanical power.

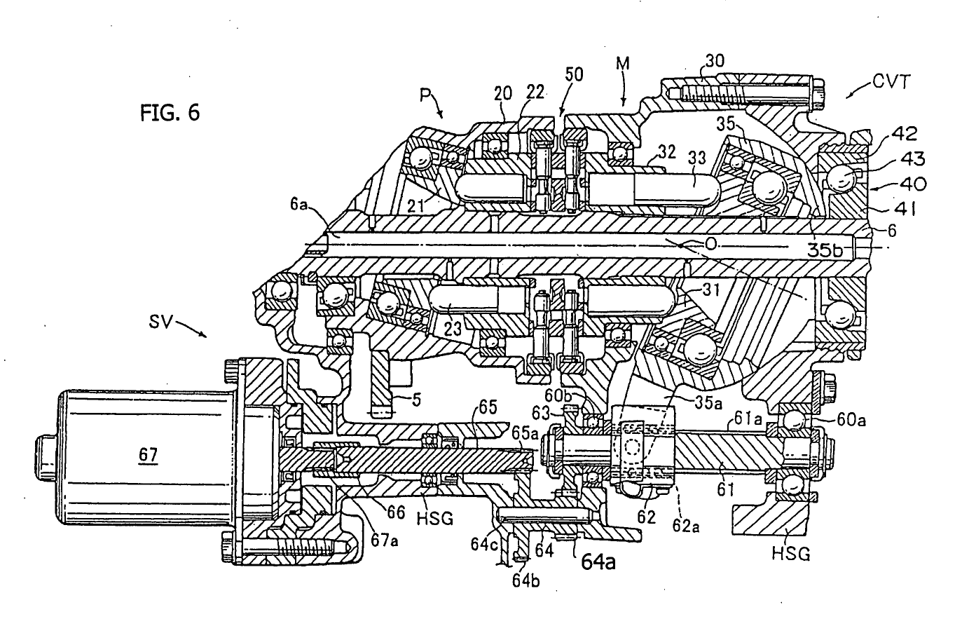

To control the motor capacity so as to be varied continuously as described above, the motor rocking member 35 is rocked to change the angle of the motor swash plate. Hereinafter, the motor servo mechanism SV for rocking the motor rocking member 35 in such manner will be described with reference mainly to FIG. 6.

The motor servo mechanism SV includes a ball screw shaft 61 located closely to the arm part 35a of the motor rocking member 35, extended in parallel to the transmission output shaft 6, and supported rotationally by bearings 60a and 60b with respect to the transmission housing HSG, as well as a ball nut 62 screwed onto the male screw 61a formed at the outer periphery of the ball screw shaft 61. A ball female screw 62a is formed by many balls held by a cage at the inner periphery of the ball nut 62. This female screw 62a is screwed onto the male screw 61a and arranged side by side in a screw form. The ball nut 62 is connected to the arm part 35a of the motor rocking member 35. When the ball screw shaft 61 is driven rotationally, therefore, the ball nut 62 moves to the right/left on the shaft 61, thereby the motor rocking member 35 rocks.

A swash plate control motor (electrical motor) 67 is attached to the outside surface of the transmission housing HSG for driving the ball screw shaft 61 rotationally in such manner. The drive shaft 67a of this swash plate control motor 67 is connected to a spacer shaft 65 through a coupling 66. The spacer shaft 65 is extended in parallel to the transmission output shaft 6 in the transmission housing HSG up to a point near the end portion of the ball screw shaft 61 over the outer periphery of the input follower gear 5. The spacer shaft 65 is supported rotationally by the transmission housing HSG. On the other hand, an idle shaft 64c extended in parallel to the spacer shaft 65 is disposed and supported by the transmission housing HSG and an idle gear member 64 is attached rotationally on the idle shaft 64c.

A first gear 65a is formed at the tip of the spacer shaft 65. This first gear 65a engages with a second gear 64b formed unitarily with the idle gear member 64. A third gear 64a, which is formed unitarily with the idle gear member 64, engages with a fourth gear 63 connected to an end portion of the ball screw shaft 61. Consequently, if the swash plate control motor 67 is controlled to be driven rotationally to rotate the drive shaft 67a, this rotation is transmitted to the fourth gear member 63 through the idle gear part 64 to drive the ball screw shaft 61 rotationally, thereby the ball nut 62 moves to the right/left on the shaft 61 and the motor rocking member 35 is controlled to rock.

When the operating oil flows through the closed hydraulic circuit to transmit a hydraulic force between the hydraulic pump P and the hydraulic motor M as described above, sometimes the operation oil leaks from the closed hydraulic circuit and from the fitting portions between the pump and the motor plunger holes 22a and 32a, as well as from the fitting portions between the pump and the motor plungers 23 and 33. To offset such oil leaks, a charge oil supply hole 6a is formed so as to be extended axially to the transmission output shaft 6. As shown in FIG. 7, this hole 6a communicates with a first check valve CV1 disposed in the pump cylinder 22 through an oil path 6b formed in the transmission output shaft 6 and an oil path 51e formed in the pump cylinder 22, and furthermore to the inside path 56 from the first check valve CV1 through an oil path 5 if. Consequently, the charge oil supplied from a charge oil supply source (not shown) to the charge oil supply hole 6a comes to be supplied to the inside path 56 through the first check valve CV1 as needed.

The charge oil supply hole 6a communicates with the second check valve CV2 disposed in the pump cylinder 22 through an oil path 6c formed in the transmission output shaft 6 and an oil path 51g formed in the pump cylinder 22, and furthermore to the outside path 57 from the second check valve CV2 through an oil path 51h. Consequently, the charge oil supplied to the charge oil supply hole 6a comes to be supplied to the outside path 57 through the second check valve CV2 as needed.

As will be understood from the description of the function of the hydraulic pump P and the hydraulic motor M, the pressure in the outside path 57 becomes high and the pressure in the inside path 56 becomes low in the normal running state, that is, when the hydraulic motor M is driven rotationally with the operation oil supplied from the hydraulic pump P. Consequently, the charge oil is charged in the inside path 56 through the first check valve CV1. While the vehicle is running on an engine braking action, however, the pressure in the outside path 57 becomes low and the pressure in the inside path 56 becomes high. The charge oil is thus supplied into the outside path 57 through the second check valve CV2.

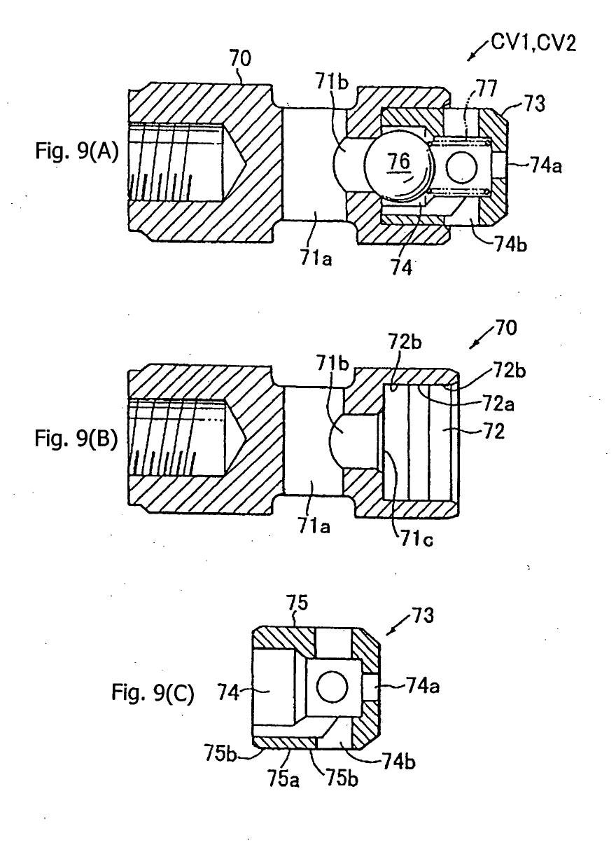

Next, the configuration of the first/second check valve CV1/CV2 will be described with reference to FIGS. 9(A) and 10(A). The first/second check valve CV1/CV2 is configured by a valve body 70, a insert member 73, a check ball (valve element) 76, and a spring 77.

The valve body 70, as shown in FIG. 9B, includes a first communicating hole 71a formed as an axial though-hole at a right angle to the object shaft and a second communicating hole 71b communicated with the first one 71a and formed as an axial through-hole. Furthermore, the valve body 70 includes a cylindrical fitting recess part 72 opened at its one end (the right end side in FIG. 9B). The inner diameter of this fitting recess part 72, as shown as an expanded view in FIG. 10A, includes a reduced diameter recess part of which diameter is slightly reduced at the center portion 72a from the right and left side portions 72b. The size of the right and left side portions 72b is, for example, 6.54 to 6.59 mm while the size of the center portion (recessed reduced diameter part) 72a is, for example, 6.50 to 6.52 mm.

The insert member 73, as shown in FIG. 9C, is formed cylindrically as a whole. Its one side (left side in FIG. 9C) is protruded as a fitting projection part 75 to be fit in the fitting recess part 72. The outer periphery of this fitting projection part 75, as shown in FIG. 10A as an expanded view, is formed as a reduced diameter projection part of which diameter is reduced slightly at its center portion 75a from the right and left portions 75b. The size of the right and left portions 75b is, for example, 6.52 to 6.53 mm while the size of the center portion (reduced diameter projection part) 75a is, for example, 6.44 to 6.47 mm. Inside the insert member 73 is formed a accommodating space 74 that is a cylindrical recess part opened at its one end (the left side in FIG. 10C). Third communicating holes 74a and 74b are formed as shown in FIG. 9A so as to enable the accommodating space 74 to communicate externally of the valve.

The fitting projection part 75 is press-fit in the fitting recess part 72 to attach the insert member 73 to the valve body 70 as shown in FIG. 9A. At that time, the left side 75b of the fitting projection part 75 goes over the center reduced diameter part 72a of the fitting recess part 72 to be press-fit in the left side part 72b of the fitting recess part 72 as shown in FIG. 10A and the center reduced diameter part 72a of the fitting recess part 72 goes into the center reduced diameter part 75a of the fitting projection part, thereby the insert member 73 is fit and held in the valve body 70. Thus, the insert member 73 is easily attached to the valve body 70 easily only by press-fitting the fitting projection part 75 into the fitting recess part 72.

The check ball 76 and the spring 77 are disposed as shown in FIGS. 9(A) and 10(A) in the accommodating space 74 when the insert member 73 is attached in such manner. The check ball 76 is pushed by the spring to close the opening 71c of the second communicating hole 71b. The check ball 76 is pushed by a charge oil pressure supplied to the first and second communicating holes 71a and 71b. The charge oil pressure, when it is higher than the oil pressure in the outside path 57, corresponding to that in the accommodating space 74 or inside path 56, pushes the check ball 76 to open the opening 71c, thereby the charge oil is supplied.

In another or alternative embodiment of the invention as shown in FIG. 10(B), it is also possible that the diameter of the center portion 72a′ is slightly expanded from the right and left portions 72b′ in the fitting recess part of the valve body 70′ to form the diameter expanded recess part while the diameter of the center portion 75a′ is slightly expanded from the right and left portions 75b′ at the fitting projection part 75′of the insert member 73′ to form the diameter expanded projection part. Even in this case, the diameter expanded projection part 75a′ is press fit in the diameter expanded recess part 72a′, making it easy to attach the insert member 73′ to the valve body 70′.

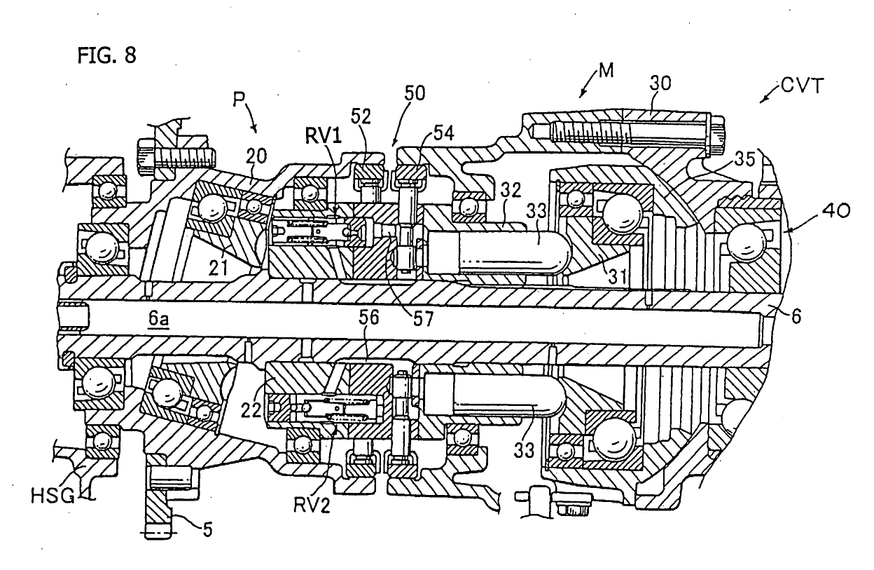

As shown in FIG. 8, first and second relief valves RV1 and RV2 are also disposed in the pump cylinder 22. The first relief valve RV1 is disposed to connect the outside path 57 and the inside path 56 to each other so that the first relief valve RV1 opens when the oil pressure in the outside path 57 rises over a predetermined value to enable the pressure to be discharged to the inside path 56, thereby preventing the oil pressure in the outside path 57 from rising excessively. The second relief valve RV2 is disposed to connect the inside path 56 and the outside path 57 to each other so that the second relief valve RV2 opens when the oil pressure in the inside path 56 rises over a predetermined value to enable the pressure to be discharged to the outside path 57, thereby preventing the oil pressure in the inside path 56 from rising excessively.

As described above, according to the present invention, because a annular reduced diameter recess part is formed at part of the inner peripheral surface of a fitting recess part of the valve body and a annular reduced diameter projection part is formed at part of the outer periphery surface of a fitting projection part of the insert member such that the reduced diameter projection part must be press-fit in the fitting recess part, then fit in the reduced diameter recess part, so that the fitting projection part is fit in the fitting recess part. Particularly, if the insert member is attached to the valve body by fitting the fitting projection part in the fitting recess part, the reduced diameter projection part is press-fit in the fitting recess part, then fit in the reduced diameter recess part, thereby the fitting projection part is fit in the fitting recess part, also thereby attaching the insert member to the valve body. Thus, the insert member attached to the valve body is easily kept in such desired state only by fitting one in the other referred to as the valve body and the insert member. The attaching mechanism is very simple in structure.

Also, as understood from FIG. 10(B), it is possible to form a annular diameter expanded recess part at part of the inner peripheral surface of a fitting recess part and a annular diameter expanded projection part at part of the outer peripheral surface of a fitting projection part so that the diameter expanded projection part is press-fit in the fitting recess part, then fit in the diameter expanded recess part, such that the fitting projection part is fit in the fitting recess part and the insert member is attached to the valve body.

Although the present invention has been described herein with respect to specific illustrative embodiments thereof, the foregoing description is intended to be illustrative, and not restrictive. Those skilled in the art will realize that many modifications of the embodiments could be made which would be operable. All such modifications which are within the scope of the claims are intended to be within the scope and spirit of the present invention.

Having thus, described the invention, what is claimed is:

1. A check valve, comprising:
a valve body having an axial through-communicating oil path and a cylindrical fitting recess part opened at an axial end thereof;
an insert member having a cylindrical fitting projection part fitted in said fitting recess part to attach the insert member to the valve body, and also having a accommodating space therein opened at one side of the insert member near said fitting projection part; and
a valve element and a spring disposed in said accommodating space such that said valve element is normally urged by said spring to close an opening of said communicating oil path;
said cylindrical fitting recess part having one of an annular reduced diameter portion and an annular expanded diameter portion at an inner periphery thereof;
said cylindrical fitting projection part having a corresponding one of an annular reduced diameter portion and an annular expanded diameter portion at an outer periphery thereof; and
diameters of said fitting recess part and said fitting projection part, including said annular reduced diameter portions or said annular expanded diameter portions, are such that said insert member is press-fitted to said fitting recess part when attaching the insert member to the valve body.

2. A check valve according to claim 1, wherein said cylindrical fitting recess part has an annular reduced diameter portion at the inner periphery thereof; and
said cylindrical fitting projection part has a corresponding an annular reduced diameter portion at the outer periphery thereof.

3. A check valve according to claim 1, wherein said cylindrical fitting recess part has an annular expanded diameter portion at the inner periphery thereof; and
said cylindrical fitting projection part has a corresponding an annular expanded diameter portion at the outer periphery thereof.

4. A check valve according to claim 1, wherein said annular reduced diameter portions or said annular expanded diameter portions of said cylindrical fitting recess part and cylindrical fitting projection part oppose each other when said insert member is attached to said valve body.

5. A check valve according to claim 2, wherein the diameter of a portion of said fitting projection part other than said annular reduced diameter portion thereof being smaller than the diameter of a portion of said fitting recess part other than said annular reduced diameter portion thereof.

6. A check valve according to claim 3, wherein the diameter of a portion of said fitting projection part other than said annular expanded diameter portion thereof being smaller than the diameter of a portion of said fitting recess part other than said annular reduced diameter portion thereof.

7. A check valve according to claim 5, wherein said diameter of said portion of said fitting projection part other than said annular reduced diameter portion thereof is larger than or equal to the diameter of said annular reduced diameter portion of said fitting recess part.

8. A check valve according to claim 6, wherein said diameter of said annular expanded diameter portion of said fitting projection part is larger than or equal to the diameter of said portion of said fitting recess part other than said annular expanded diameter portion thereof.

9. A check valve according to claim 2, wherein said annular reduced diameter portions are longitudinally intermediate portions of said fitting projection part and said fitting recess part.

10. A check valve according to claim 3, wherein said annular expanded diameter portions are longitudinally intermediate portions of said fitting projection part and said fitting recess part.

11. A continuously variable transmission comprising the check valve according to claim 1.

12. A check valve for use in a hydraulic flow passage, comprising:
a valve body having an axial oil path formed therein, and having a cylindrical fitting recess formed in one end thereof in communication with said oil path, wherein a valve seat is defined where said fitting recess joins said axial oil path;
an insert member adapted to fit in said fitting recess of said valve body, said insert member including a cylindrical fitting projection and having an accommodating space defined therein; and
a valve element and a spring disposed in said accommodating space when said fitting projection is installed in said fitting recess to attach said insert member to said valve body;
said valve element being normally biased against said valve seat by said spring to block fluid flow through said axial oil path; and
said cylindrical fitting projection of said insert member is press-fit into said fitting recess of said valve body to form an interference fit therebetween effective to retain said insert member in engagement with said valve body.

13. The check valve of claim 12, wherein:
a first cylindrical surface within said check valve, selected from an inner wall of said cylindrical fitting recess and an outer wall of said cylindrical fitting projection, has an annular raised rib provided therearound;
a second cylindrical surface within said check valve, which is the other of said inner wall of said cylindrical fitting recess and said outer wall of said cylindrical fitting projection, has an annular groove formed therearound corresponding to said raised rib; and
said raised rib is disposed opposite to said annular groove when said insert member is attached to said valve body.

14. The check valve of claim 12, wherein said valve member is substantially spherical in shape.

15. The check valve of claim 13, wherein outer wall of said cylindrical fitting projection includes said annular raised rib, and said annular groove is formed in said inner wall of said cylindrical fitting recess.

16. The check valve of claim 13, wherein said annular groove is formed in said outer wall of said cylindrical fitting projection, and said annular raised rib is formed on said inner wall of said cylindrical fitting recess.

17. A check valve for use in a hydraulic flow passage, comprising:
a valve body having an axial oil path formed therein, and having a cylindrical fitting recess formed in one end thereof in communication with said oil path, wherein a valve seat is defined where said fitting recess joins said axial oil path;
an insert member adapted to fit in said fitting recess of said valve body, said insert member comprising a cylindrical fitting projection having an accommodating space defined therein; and
a valve element and a spring disposed in said accommodating space when said fitting projection is installed in said fitting recess to attach said insert member to said valve body;
said valve element being normally biased against said valve seat by said spring to block fluid flow through said axial oil path;
a first cylindrical surface, selected from an inner wall of said cylindrical fitting recess and an outer wall of said cylindrical fitting projection, has a raised annular rib extending therearound, and a second cylindrical surface which is the other of said inner wall of said cylindrical fitting recess and the outer wall of said cylindrical fitting projection, has an annular groove formed therearound corresponding to said raised annular rib; and
said cylindrical fitting projection of said insert member is press-fit into said cylindrical fitting recess of said valve body to form an interference fit therebetween effective to retain said insert member in engagement with said valve body.
